(19) United States
(12) Patent Application Publication
(10) Pub. No.: US 2006/0107208 A1
(43) Pub. Date: May 18, 2006

(54) Operation management terminal program, operation management terminal, and relay program

(75) Inventors: Hideo Sugimori, Kawasaki (JP); Masaki Furuhashi, Nagoya (JP)

Correspondence Address: Patrick G. Burns, Esq.;GREER, BURNS & CRAIN, LTD., Suite 2500, 300 South Wacker Drive, Chicago, IL, 60606, US

(73) Assignee: FUJITSU LIMITED

(21) Appl. No.: 11/043,448

(22) Filed: Jan. 26, 2005

(30) Foreign Application Priority Data
Oct. 29, 2004 (JP) 2004-316630

(51) Int. Cl. G06F 17/21

(52) U.S. Cl. 715/526

(57) ABSTRACT

An operation management terminal is controlled to display message information for system management output form a plurality of system management units in an integrated fashion. A rule is acquired for selecting a management screen most related to predetermined message information from among a plurality of Web-based management screens provided by the system management units. Information is acquired in which a parameter necessary for displaying the management screen selected is defined. A management screen that is most related to one of the message information displayed in an integrated fashion is selected based on the information acquired. A Web-based management screen selected is displayed on a Web browser based on the parameter defined in the information acquired.

### BACKGROUND OF THE INVENTION

1) Field of the Invention

The present invention relates to a technology for controlling an operation management terminal to display message information for system management output form a plurality of system management units in an integrated fashion.

2) Description of the Related Art

With a spread of a so-called open system, it has now become common to build information processing systems by combining hardware and software from a variety of vendors. In such a multi-vendor environment, however, the system manager is required to acquire a proficiency in the operation systems that are uniquely provided by each of the hardware and the software, which is quite a big burden on the system manager.

Operation management systems that reduce the burden on the system managers have been developed. In these operation management systems, management of different hardware and software is performed in an integrated fashion using a unified system.

One of the significant functions of the operation management system is a message management function that includes collecting messages addressed to the system manager and displaying the message on a monitor. These messages are the ones that the hardware or the software output to a log file and the like. With this function, the system manager can figure out an error occurred in all of the hardware and the software and a sign for an error only by observing the monitor.

Besides, when a message indicating an occurrence of an error or a sign for an error is displayed on the monitor, the system manager can refer to detailed information on the error on the operation management terminal. This function is implemented by communicating with an agent prepared in advance in a server to be monitored to exchange necessary information.

Related technologies have been disclosed in Japanese Patent Application Laid Open Publication No. H07-230424 and Japanese Patent No. 2000-207372.

On the other hand, with a recent improvement of the Internet, a variety of hardware and software provide screens for the system manager, which is viewable on a Web browser. Some of those screens visually provide information about an operation status and the like, which is an extremely useful tool for the system manager to take an appropriate countermeasure against the error.

However, a conventional operation management system can hardly take a close cooperation with such Web-based management screens. For this reason, when a message indicating an occurrence of an error or a sign for an error is displayed on the monitor, the system manager has a problem in referring to such Web-based management screens to take a prompt countermeasure against the error.

### SUMMARY OF THE INVENTION

It is an object of the present invention to solve at least the problems in the conventional technology.

An operation management terminal according to an aspect of the present invention displays message information for system management output form a plurality of system management units in an integrated fashion. The operation management terminal includes a rule acquiring unit that acquires a rule for selecting a management screen most related to predetermined message information from among a plurality of Web-based management screens provided by the system management units; an information acquiring unit that acquires information in which a parameter necessary for displaying the management screen selected is defined; a management screen selecting unit that selects a management screen most related to one of the message,information displayed in an integrated fashion, based on the information acquired by the information acquiring unit; and a management screen displaying unit that displays a Web-based management screen selected by the management screen selecting unit on a Web browser, using the parameter defined in the information acquired by the information acquiring unit.

A method according to another aspect of the present invention is a method of controlling an operation management terminal to display message information for system management output form a plurality of system management units in an integrated fashion. The method includes acquiring a rule for selecting a management screen most related to predetermined message information from among a plurality of Web-based management screens provided by the system management units; acquiring information in which a parameter necessary for displaying the management screen selected is defined; selecting a management screen most related to one of the message information displayed in an integrated fashion, based on the information acquired at the acquiring information; and displaying a Web-based management screen selected at the selecting on a Web browser, using the parameter defined in the information acquired at the acquiring information.

A relay apparatus according to still another aspect of the present invention relays information relating to displaying a screen between a system management unit that provides a Web-based management screen and a Web server. The relay apparatus includes a parameter acquiring unit that acquires a parameter included in a request received by the Web server; a parameter complementing unit that complements a parameter necessary for displaying a management screen provided by the system management unit, using the parameter acquired by the parameter acquiring unit; a screen acquiring unit that acquires screen data by having the system management unit create a management screen using the parameter acquired by the parameter acquiring unit and the parameter complemented by the parameter complementing unit; and a screen transmitting that transmits the screen data acquired by the screen acquiring unit to the Web server.

A method according to still another aspect of the present invention is a method of relaying information relating to displaying a screen between a system management unit that provides a Web-based management screen and a Web server. The method includes acquiring a parameter included in a request received by the Web server; complementing a parameter necessary for displaying a management screen provided by the system management unit, using the parameter acquired at the acquiring a parameter; acquiring screen data by having the system management unit create a management screen using the parameter acquired at the acquiring a parameter and the parameter complemented at the complementing; and transmitting the screen data acquired at the acquiring screen data to the Web server.

The computer program products according to still other aspects of the present invention implement the above methods on a computer.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic diagram of an example of operation environment for an operation management system according to a first embodiment of the present invention;

FIG. 2 is a schematic diagram of an outline of a management screen display procedure performed by the operation management system according to the first embodiment;

FIG. 3 is a block diagram of an operation management terminal program shown in FIG. 2;

FIG. 4 depicts in a tabular form exemplary contents of a message log DB according to the first embodiment;

FIG. 5 is a schematic diagram of an example of a message list screen according to the first embodiment;

FIG. 6 depicts in a tabular form exemplary contents of management screen call definition information according to the first embodiment;

FIG. 7 is a schematic diagram of an example of a management screen according to the first embodiment;

FIG. 8 is a flowchart of a process procedure performed by the operation management terminal program shown in FIG. 3;

FIG. 9 is a block diagram of a computer that executes the operation management terminal program shown in FIG. 3;

FIG. 10 is a schematic diagram of an outline of a management screen display procedure performed by an operation management system according to a second embodiment of the present invention;

FIG. 11 is a block diagram of an operation management terminal program shown in FIG. 10;

FIG. 12 depicts in a tabular form exemplary contents of management screen call definition information according to the second embodiment;

FIG. 13 depicts an exemplary code of a Web page created by the operation management terminal program shown in FIG. 11;

FIG. 14 is a block diagram of the relay program shown in FIG. 10;

FIG. 15 is a flowchart of a process procedure performed by the operation management terminal program shown in FIG. 11;

FIG. 16 is a flowchart of a process procedure performed by the relay program shown in FIG. 14; and

FIG. 17 is a schematic diagram of an outline of a management screen display procedure performed by a convention operation management system.

### DETAILED DESCRIPTION

Exemplary embodiments of the present invention will be explained in detail below with reference to the accompanying drawings.

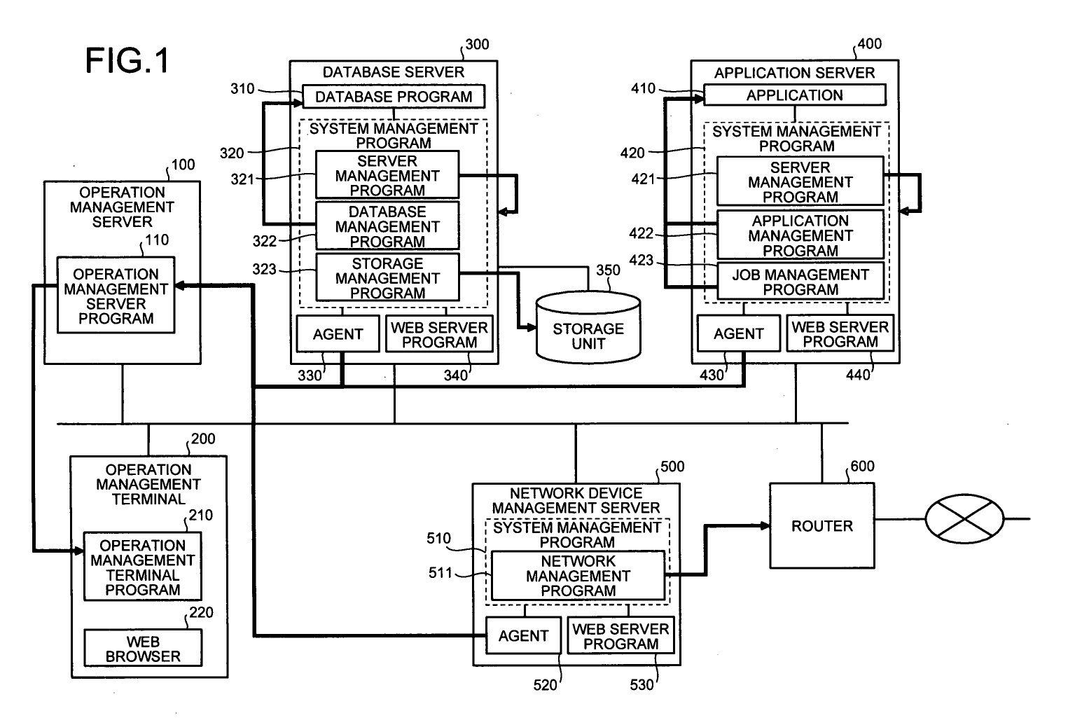

FIG. 1 is a schematic diagram of an example of operation environment for an operation management system according to a first embodiment of the present invention. The operation management system includes an operation management server 100, an operation management terminal 200, and a variety of other servers. The servers are connected to each other via a network.

The operation management server 100 runs an operation management server program 110 that controls the whole operation management system. The operation management terminal 200 runs an operation management terminal program 210 that displays information transmitted from the operation management server program 110, and makes a request for executing various types of processes to the operation management server program 110. The operation management terminal 200 also runs a Web browser 220 to browse Web pages.

A database server 300 runs a database program 310 that provides a database function. The database server 300 also runs a variety of system management programs 320, an agent 330, and a Web server program 340.

A server management program 321, one of the system management programs 320, performs monitoring and control of hardware and operation system (OS) of the database server 300. A database management program 322 performs monitoring and control of the database program 310. A storage management program 323 performs monitoring and control of a storage unit 350 that is a large capacity storage unit connected to the database server 300.

The agent 330 acquires messages addressed to a system manager and output to a log file and the like from the database management program 322 and the storage management program 323, and transmits the message to the operation management server program 110. The Web server program 340 releases, to a network, a Web page and the like for the system manager provided by the server management program 321, the database management program 322, and the storage management program 323.

An application server 400 runs an application 410 that provides a variety of operation processes. The application server 400 also runs a variety of system management program 420, an agent 430, and a Web server program 440.

A server management program 421, one of the system management programs 420, performs monitoring and control of hardware and OS of the application server 400. An application management program 422 performs monitoring and control of the application 410. A job management program 423 performs monitoring and control of an execution schedule for various programs including the application 410.

The agent 430 acquires a message for a system manager output to a log and the like from the application management program 422 and the job management program 423, and transmits the message to the operation management server program 110. The Web server program 440 releases, to a network, a Web page and the like for the system manager provided by the server management program 421, the application management program 422, and the job management program 423.

A network device management server 500 manages a variety of network devices including a router 600, and runs a variety of system management programs 510, an agent 520, and a Web server program 530.

A network management program 511, which is one of the system management programs 510, performs monitoring and control of the variety of network devices including the router 600. The agent 520 acquires a message for a system manager output to a log and the like from the network management program 511, and transmits the message to the operation management server program 110. The Web server program 530 releases, to a network, a Web page and the like for the system manager provided by the network management program 511.

In this manner, in the operation environment described as an example so far, various system management programs are operated, in the database server 300, the application server 400, and the network device management server 500. The message for the system manager output from the above servers is acquired by an agent of each of the servers, and transmitted to the operation management server program 110. The operation management server program 110 receives the message, and transmits the message to the operation management terminal program 210, after shaping the message. Then the operation management terminal program 210 outputs the message received to a monitor. With this mechanism, error information and warning information of all the servers are displayed in an integrated fashion on the monitor of the operation management terminal 200.

When details of the error information or the warning information is needed, the system manager can refer to Web pages provided by each of the system management programs by making an access to a Web server program provided by each of the system management programs using the Web browser 220 of the operation management terminal 200.

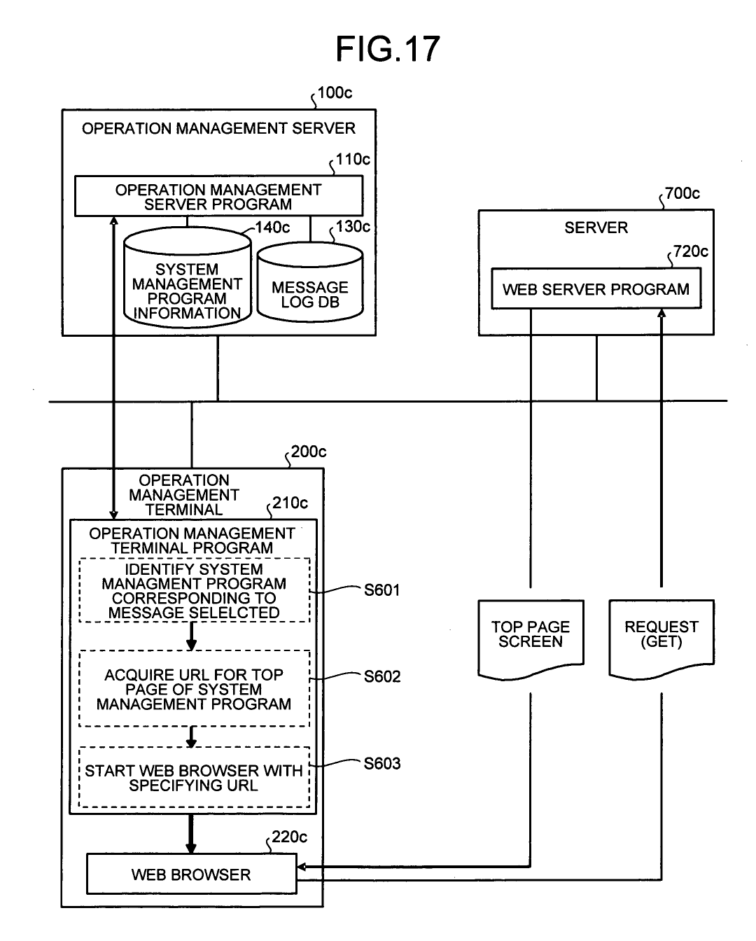

A cooperation between a Web-based management screen provided by a variety of system management programs and a conventional operation management system is explained. FIG. 17 is a schematic diagram of an outline of a management screen display procedure performed by the convention operation management system. The figure illustrates an operation of the operation management system when a message indicating an occurrence of an error on an operation management terminal 200c so that a system manager selects the message on a screen, and instructs to display a Web-based management screen relating to the message.

Upon receiving an instruction from the system manager, an operation management terminal program 210c running on the operation management terminal 200c identifies a system management program that is a source of the message selected (Step S601), acquires a uniform resource locator (URL) for a top page of a Web-based management screen provided by the system management program identified form system management program information 140c of an operation management server 100c (Step S602), and starts a Web browser 220c with specifying the URL acquired (Step S603).

The Web browser 220c makes a request for transmitting a top page specified to a Web server program 720c of a server 700c indicated by the URL specified. Then, the Web server program 720c transmits the top page requested.

In this manner, a top page of a Web-based management screen provided by a system management program that is a source of a message is displayed on the Web browser 220c. Then, the system manager searches necessary information by performing a drill down operation from the top page.

As described above, in the conventional operating management system, a cooperation with a Web-based management screen provided by a system management program is not sufficient, it is not possible to directly display a Web-based management screen most related to a message displayed on the operation management terminal 200c.

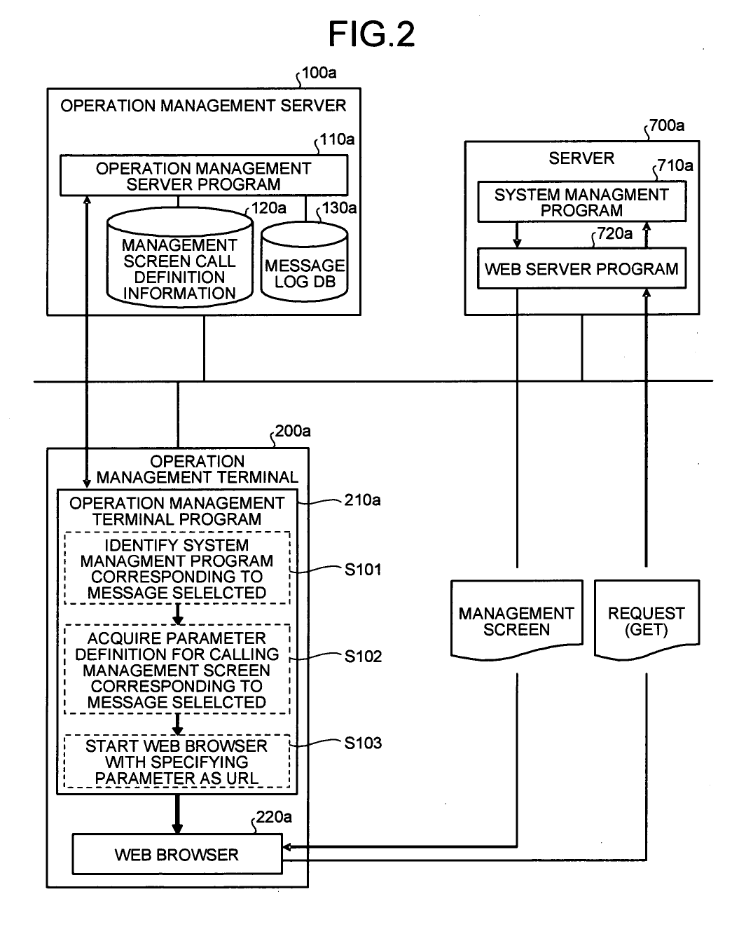

Now, a cooperation between a Web-based management screen provided by a variety of system management programs and the operation management system according to the present embodiment is explained. FIG. 2 is a schematic diagram of an outline of a management screen display procedure performed by the operation management system according to the first embodiment. FIG. 2 illustrates, in the same way as in FIG. 17, an operation of the operation management system when a message indicating an occurrence of an error on an operation management terminal 200a so that a system manager selects the message on a screen, and instructs to display a Web-based management screen relating to the message.

Upon receiving an instruction from the system manager, an operation management terminal program 210a running on the operation management terminal 200a identifies a system management program that is a source of the message selected (Step S101), acquires a parameter for calling a management screen most related to the message from a management screen call definition information 120a, based on the system management program identified and a content of the message (Step S102), and starts a Web browser 220a with specifying the parameter acquired as a URL (Step S103).

The Web browser 220a makes a request for transmitting a management screen specified to a Web server program 720a of a server 700a indicated by the URL specified. Then, the Web server program 720a makes a request for creating the management screen specified to a system management program 710a, and transmits the management screen created to the Web browser 220a.

In this manner, a Web-based management screen most related to a message displayed on the operation management terminal 200a is displayed on the Web browser 220c. Then, the system manager can refer to necessary information by performing a drill down operation on the management screen displayed.

As described above, the operation management system according to the present embodiment closely cooperates with a Web-based management screen provided by the system management program, thereby a Web-based management screen most related to the message displayed on the operation management terminal 200a is automatically selected and displayed.

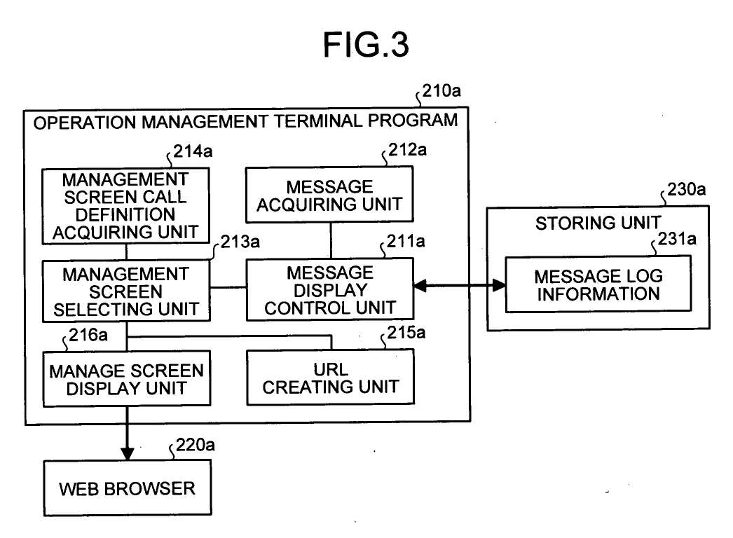

FIG. 3 is a block diagram of the operation management terminal program 210a shown in FIG. 2. The operation management terminal program 210a includes a message display control unit 211a, a message acquiring unit 212a, a management screen selecting unit 213a, a management screen call definition acquiring unit 214a, a URL creating unit 215a, and a management screen display unit 216a.

The message display control unit 211a outputs a message acquired by the message acquiring unit 212a from an operation management server 100a to a message list screen, and notifies an instruction received from a user of the message list screen to other processing unit such as the management screen selecting unit 213a. The message acquiring unit 212a acquires information added to a message log DB 130a, and delivers the information acquired to the message display control unit 211a. The message acquired by the message display control unit 211a from the operation management server 100a is temporarily stored in a storing unit 230a of the operation management terminal 200a as message log information 231a.

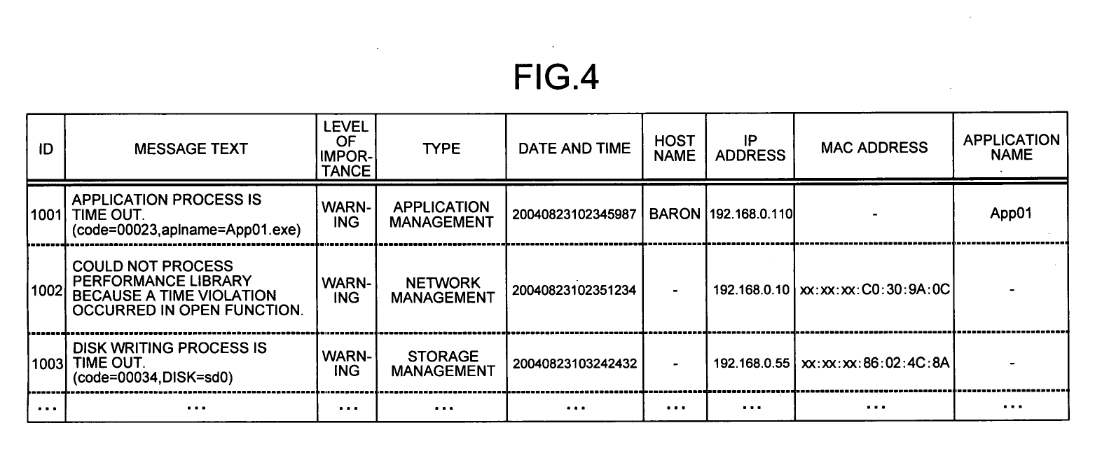

FIG. 4 depicts in a tabular form exemplary contents of the message log DB 130a. The message log DB 130a includes data items, such as ID, message text, level of importance, type, date and time, host name, IP address, MAC address, and application name.

The ID is an identification number to identify each of the data. The message text is a main body included in a message transmitted from an agent. The level of importance represents a seriousness of the data, with values “error”, “warning”, “notification”, and “information” in order of high importance. The type indicates a source of the message, namely, a system management program from which the error has occurred. The date and time indicates date and time of occurrence of the error.

The host name, the IP address, the MAC address, and the application name indicate the host name, the IP address, the MAC address, and the application name of the source of the error, respectively, and only necessary items are set according to the type from among the above items.

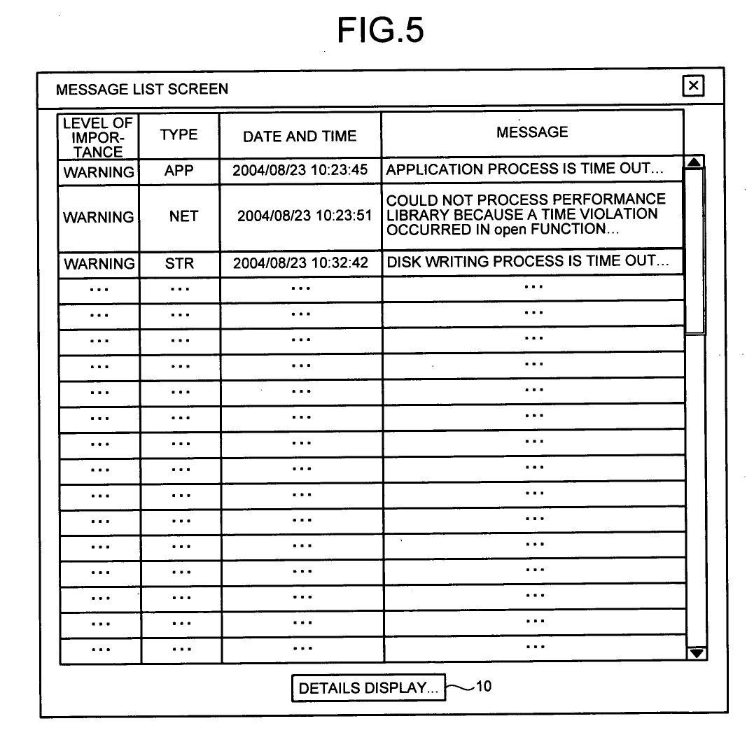

FIG. 5 is a schematic diagram of an example of a message list screen according to the first embodiment. As shown in the figure, on the message list screen, level of importance, type, date and time, and a message are displayed in a list. These items are corresponding to the level of importance, the type, the date and time, and the message text in the message log DB 130a, respectively. In this example, the type is displayed in a form of abbreviation, and the date and time is shaped in a format that is easy to recognize. By selecting a specific row from the list and pressing a details display button 10, a Web-based management screen most related to the message selected is displayed.

The management screen selecting unit 213a receives a notification that there is an instruction to display a Web-based management screen and information on a content of a message designated by the instruction from the message display control unit 211a, acquires information for selecting and calling a Web-based management screen from the management screen call definition acquiring unit 214a, selects information on a management screen most related to the message from among the information acquired, and instructs the management screen display unit 216a to display the management screen.

The management call definition acquiring unit 214a is a processing unit that acquires information from the management screen call definition information 120a of the operation management server 100a based on the instruction from the management screen selecting unit 213a, and delivers the information acquired to the management screen selecting unit 213a.

The management screen call definition information 120a is not necessarily to be stored in the operation management server 100a, but may be stored in other server or the operation management terminal 200a. Then, the management screen call definition acquiring unit 214a acquires the same information from a place where the management screen call definition information 120 is stored.

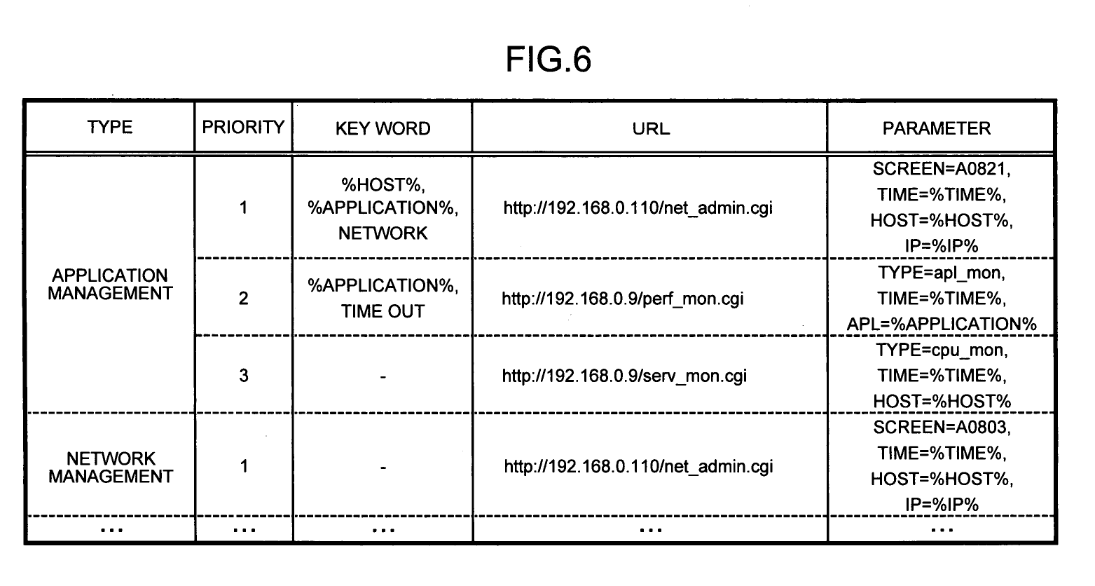

FIG. 6 depicts in a tabular form exemplary contents of the management screen call definition information 120a according to the first embodiment. The management screen call definition information 120a includes data items, such as type, priority, key word, URL, and parameter.

The type corresponds to a data item of the type in the message log DB 130a, and becomes the first selection condition for selecting information most related to a message. A combination of the priority, key word, and the parameter can be maintained for one type. The priority indicates an order of priority when a plurality of data is present to which the type and the key word make a hit.

The key word contains a phrase that is matched with the message text, and becomes the second selection condition for selecting the information most related to the message. When a plurality of phrases is set in the key word, it is assumed that the key word makes a hit only when all of the phrases are included in the message text. On the other hand, when nothing is set in the key word, it is assumed that the key word makes a hit all the time.

As the phrase, a variable that is converted into a value of a specific item in a message to be compared can be set in addition to a fixed character string. For example, a variable “% HOST %” is matched with the message text after being replaced by a value of an item of the host name in the message to be compared.

The URL is an address based on which the management screen is displayed. The parameter contains optional data added to the URL to display the management screen. A part of the optional data is set as a variable in the parameter, and when the optional data is added to the URL, the URL creating unit 215a performs a conversion of the variable.

For example, if a value of
HOST=% HOST %, TIME=% TIME %
is set in the parameter, a value of the host name of a message that led to a display of the scenario display screen is “host01”, and a value of the date and time is “20040923103721”, the value in the parameter is converted into a form of
HOST=host01TIME=20040923103721.

The URL creating unit 215a is a processing unit that creates a URL to display the management screen selected by the management screen selecting unit 213a. The management screen display unit 216a starts a Web browser with specifying the URL created by the URL creating unit 215a, and have the Web browser display the management screen. The URL created by the URL creating unit 215a has following format.

http://URL acquired by the management screen call definition information 120a? optional data obtained by converting a variable in the parameter acquired from the management screen call definition information 120a

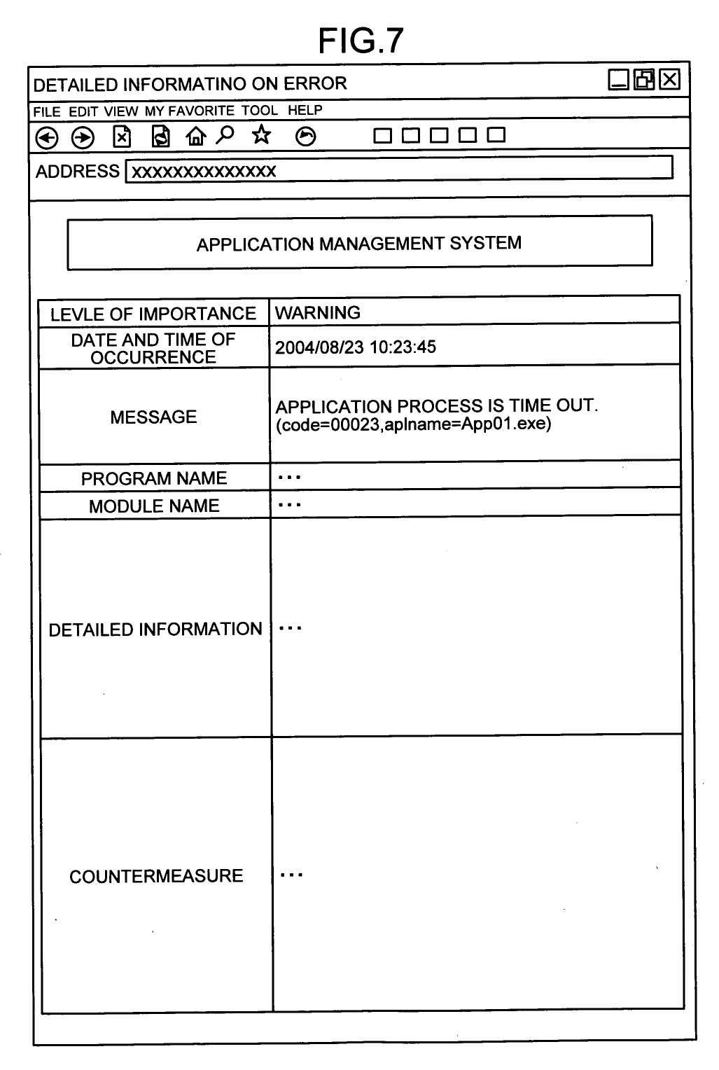

FIG. 7 is a schematic diagram of an example of a management screen according to the first embodiment. As shown in the figure, a detailed description of an error and a countermeasure against the error are displayed on the management screen. In addition, an operation status of a resource, such as a central processing unit (CPU), is visually displayed in a form of a graph. Some graphs automatically updates a content of display with time collapse.

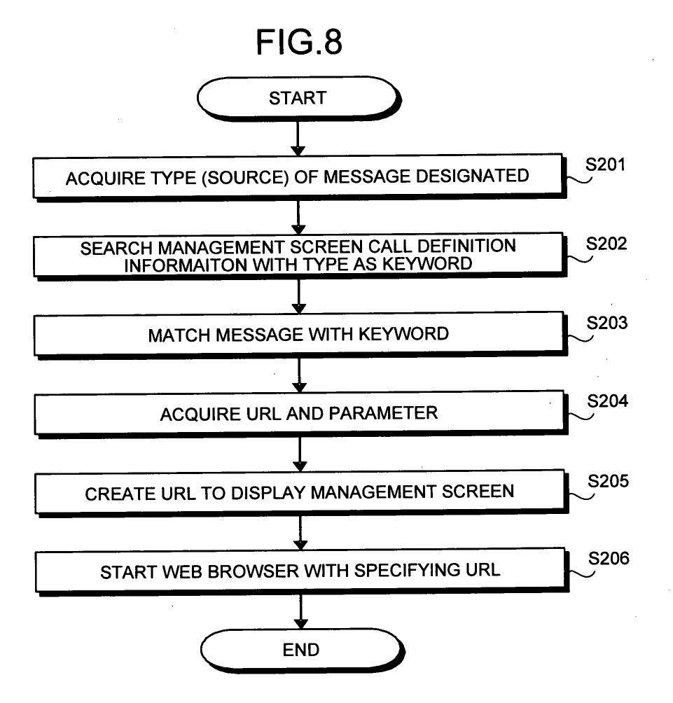

FIG. 8 is a flowchart of a process procedure performed by the operation management terminal program 210a shown in FIG. 3. When a specific message is selected from a message list screen displayed by the operation management terminal 200a, and when there is an instruction to display a management screen most related to the message selected, the message display control unit 211a receives the instruction, and notifies the instruction received to the management screen selecting unit 213a.

Upon receiving a notification from the message display control unit 211a, the management screen selecting unit 213a acquires a value of a data item of the type indicating a source of the message (Step S201), and instructs the management screen call definition acquiring unit 214a to acquire information for which the value of the type matches from the management screen call definition information 120a (Step S202).

Subsequently, the information acquired is selected one by one in an order of priority, and the information selected is checked whether the key word is matched with the message text of the message (Step S203). When there is information matched, values of items, a URL and a parameter contained in the information, are acquired (Step S204).

Then, the information acquired at the Step S204 and values of various data items in the message selected are delivered to the URL creating unit 215a to create a URL to display the management screen (Step S205), and an instruction is given to the management screen display unit 216a to start a Web browser with specifying the URL created (Step S206).

In this manner, the operation management terminal program 210a executes a process of selecting a management screen most related to a message selected and displaying the management screen selected on a Web browser.

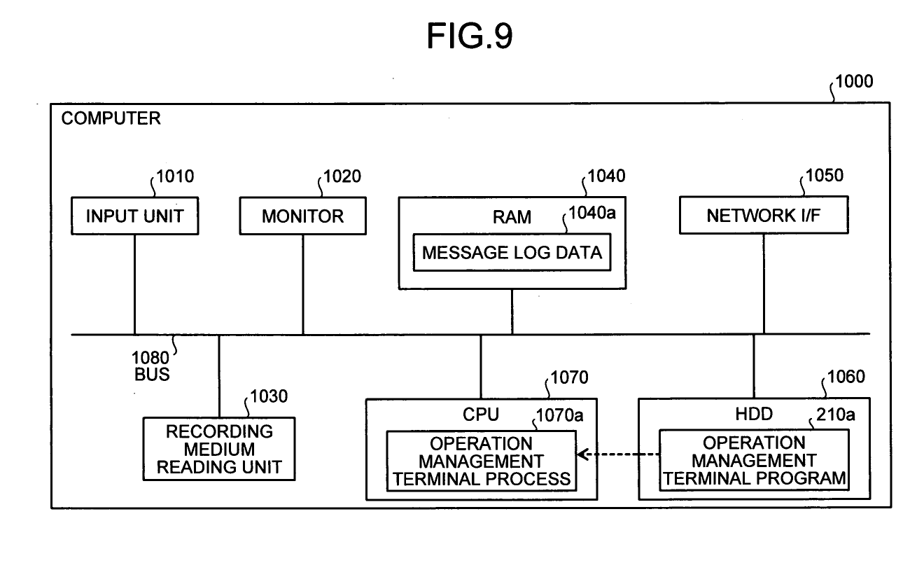

The series of processes described above can be implemented by executing a computer program prepared in advance on a computer. Following is an explanation of an example of a computer program to implement the operation management system according to the present embodiment on a computer using FIG. 9.

FIG. 9 is a block diagram of a computer that executes the operation management terminal program 210a shown in FIG. 3. A computer 1000 is configured by connecting an input unit 1010 that receives an input of data from a user, a monitor 1020, recording medium reading unit 1030 that reads a program from a recording medium that stores a variety of programs, a random access memory (RAM) 1040 that temporarily stores a variety of information, a network interface 1050 that performs exchange of data with other computer via a network, a hard disk drive (HDD) 1060, and a CPU, via a bus 1080.

The HDD 1060 stores an operation management terminal program 210a. The CPU 1070 reads the operation management terminal program 210a from the HDD 1060, and executes the program read, thereby the program becomes to work as an operation management terminal process 1070a.

Furthermore, the CPU 1070 acquires data relating to messages collected by the operation management server 100a, stores the data in the RAM 1040 as message log data 1040a, and executes various data processing based on the message log data 1040a stored in the RAM 1040.

The operation management terminal program 210a is not necessarily to be stored in the HDD 1060, but can be stored in a recording medium, such as a compact disk-read only memory (CD-ROM). Then, the computer 1000 may read the programs stored in the recording medium, and execute the programs read. In addition, the programs may be stored in other computer (or server) that is connected to the computer 1000 via a public line, the internet, a local area network (LAN), or a wide area network (WAN) so that the computer 1000 reads the programs from the other computer (or server), and executes the programs read.

As described above, according to the first embodiment, information for selecting an appropriate management screen from a content of a message and information for calling the management screen selected are stored in the management screen call definition information 120a, and a URL for selecting and calling the management screen is created using the information. Therefore, it is possible to closely link a message displayed on the operation management terminal 200a with a Web-based management screen provided by a system management program.

In the first embodiment, an example that a Web page provided by a system management program is displayed by specifying a parameter for a URL is explained. However, when a parameter necessary for displaying a Web-based management screen provided by the system management program is not included in the message log DB 130a, the method according to the first embodiment cannot be used.

When a management screen requires an authentication process using a log in with a password to be referred to, the method cannot be applied, either. Furthermore, when a page is specified using a URL, a long parameter cannot be delivered because there is a limit in a length of the URL.

In a second embodiment of the present invention, an operation management system to solve the above problems is explained.

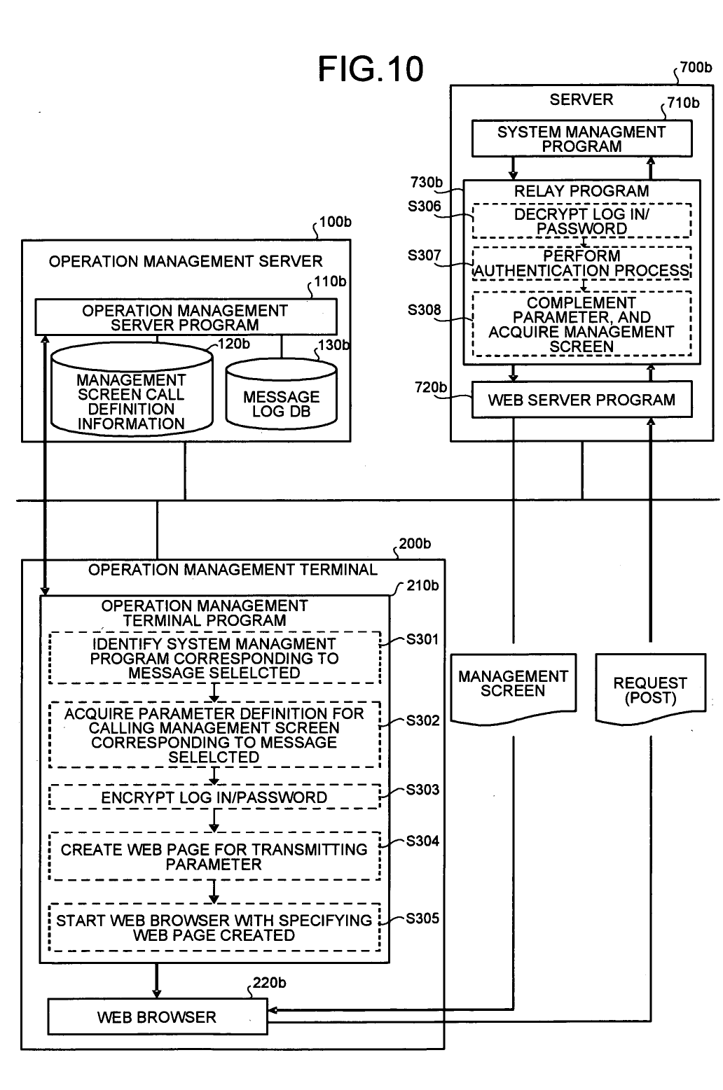

First of all, a cooperation between a Web-based management screen provided by a variety of system management programs and an operation management system according to the second embodiment is explained. FIG. 10 is a schematic diagram of an outline of a management screen display procedure performed by the operation management system according to the second embodiment. FIG. 10 illustrates, in the same way as in FIG. 2, an operation of the operation management system when a message indicating an occurrence of an error on an operation management terminal 200b so that a system manager selects the message on a screen, and instructs to display a Web-based management screen relating to the message.

Upon receiving an instruction from the system manager, an operation management terminal program 210b running on the operation management terminal 200b identifies a system management program that is a source of the message selected (Step S301), acquires a parameter for calling a management screen most related to the message from a management screen call definition information 120b, based on the system management program identified and a content of the message (Step S302).

If the parameter acquired says that an authentication process is necessary to display a management screen, a log in and a password necessary for an authentication are acquired and encrypted (Step S303). Then, a Web page for transmitting the parameter acquired as a POST request is created (Step S304), a Web browser 220b is started with specifying the Web page created (Step S305).

A mechanism to automatically issue a POST request is in the Web page created at the Step S304, using a script an the like. With this mechanism, the Web browser 220b is started with transmitting the POST request to a Web server program 720b of a server 700b to make a request for a transmission of a management screen.

The Web server program 720b makes a request for acquiring the management screen specified to a relay program 730b. The relay program 730b acquires a parameter transmitted from the Web browser 220b, if necessary, decrypts the log in and the password in the parameter (Step S306), and performs an authentication process with respect to the system management program 710b (Step S307).

Then, a parameter required for acquiring a target management screen is complemented using the parameter acquired, and a management screen is acquired from the system management program 710b with specifying the parameter acquired and the parameter complemented (Step S308). The management screen acquired is transmitted to the Web browser 220b via the Web server program 720b.

In this manner, a Web-based management screen most related to the message displayed on the operation management terminal 200b is displayed on the Web browser 220b. Then, the system manager can refer to necessary information by performing a drill down operation on the management screen displayed.

As described above, the operation management system according to the second embodiment closely cooperates with a Web-based management screen provided by the system management program, thereby a Web-based management screen most related to the message displayed on the operation management terminal 200b is automatically selected and displayed.

Even when a parameter necessary for displaying a Web-based management screen provided by the system management program is not included in the message log DB 130b, the relay program 730b searches and acquires a necessary parameter using a parameter transmitted from the Web browser 220b. For example, with only a main body of a message and a date and time, it is possible to acquire almost all the information relating to an error occurred.

Although a parameter becomes possibly long if the parameter includes a main body of a message, the length of the parameter will not cause a problem because the parameter is transmitted using a POST request in the present embodiment. Because the POST request cannot be issued using a URL, the present embodiment adopts a method of using a script such as a Java (registered trademark) script.

Furthermore, even when an authentication is necessary for displaying a management screen, the relay program 730b carries out an authentication process using a log in and a password included in a parameter transmitted from the Web browser 220b. The log in and the password are encrypted for a security.

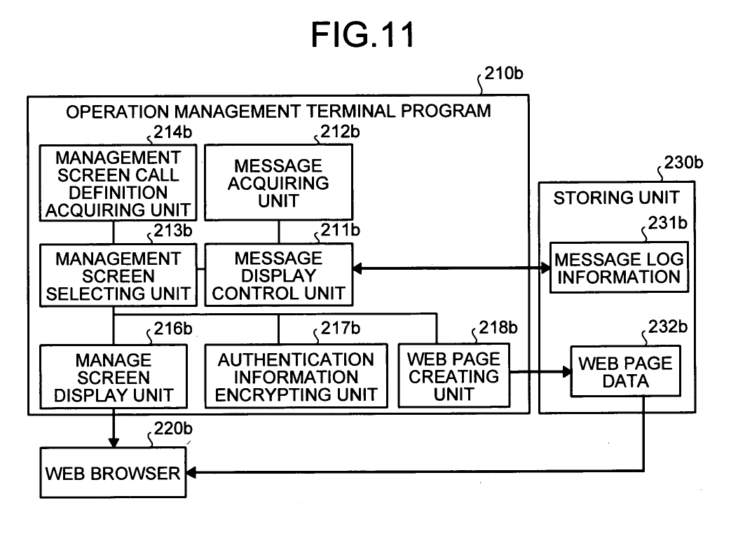

FIG. 11 is a block diagram of the operation management terminal program 210b shown in FIG. 10. The operation management terminal program 210b includes a message display control unit 211b, a message acquiring unit 212b, a management screen selecting unit 213b, a management screen call definition acquiring unit 214b, an authentication information encrypting unit 217b, a Web page creating unit 218b, and a management screen display unit 216b.

Because the message display control unit 211b, the message acquiring unit 212b, the management screen selecting unit 213b, and the management screen call definition acquiring unit 214b are the same as the message display control unit 211a, the message acquiring unit 212a, the management screen selecting unit 213a, and the management screen call definition acquiring unit 214a, explanations for those units are omitted.

The authentication information encrypting unit 217b is a processing unit that encrypts a log in and a password for an authentication. The Web page creating unit 218b is a processing unit that creates a Web page including a parameter for displaying a management screen and a script for issuing a POST request.

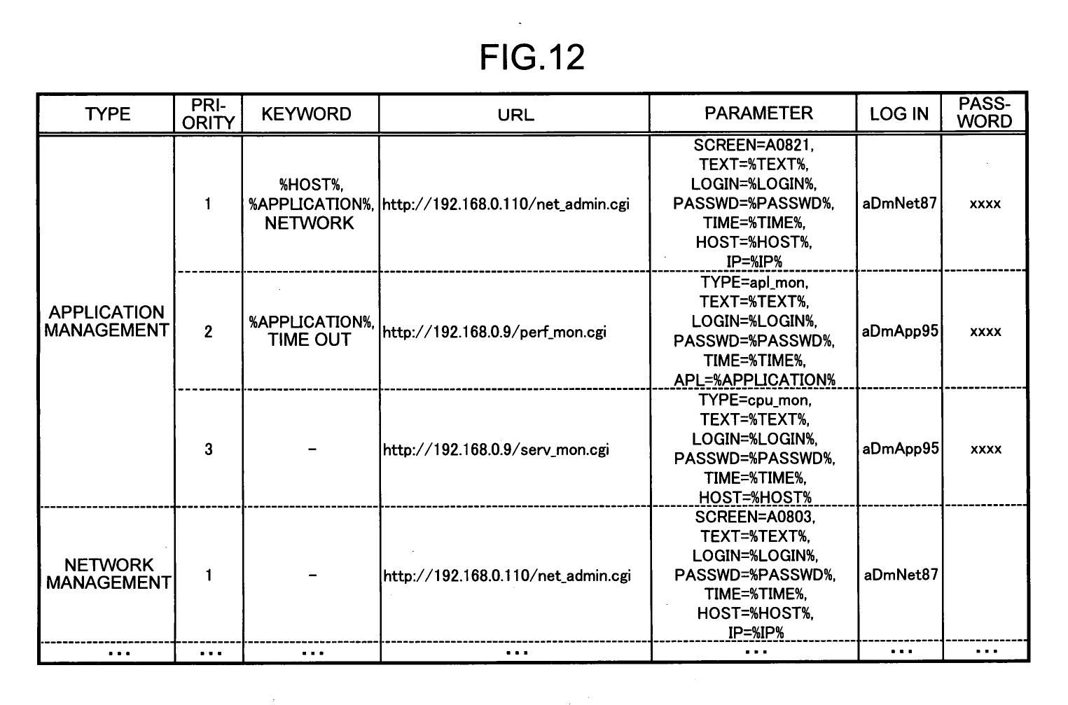

FIG. 12 depicts in a tabular form exemplary contents of management screen call definition information 120b according to the second embodiment. The management screen call definition information 120b includes an item for the log in and the password, in addition to the items included in the management screen call definition information 120a shown in FIG. 6. The log in and the password are necessary for accessing a page indicated by an item of a URL.

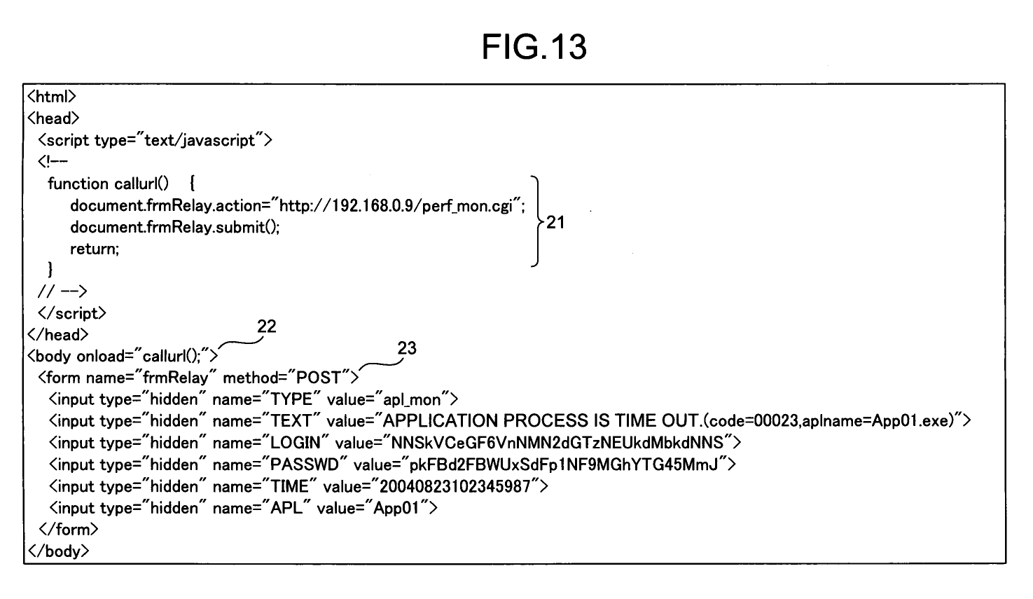

FIG. 13 depicts an exemplary code of a Web page created by the operation management terminal program 210b according to the second embodiment. This Web page is for displaying a management screen most related to the message with the ID 1001 shown in FIG. 4. When displaying the management screen most related to the message, a Web page is created based on the information on the second row of the management screen call definition information 120b shown in FIG. 12.

A function unit 21 is a script for issuing a request to the Web server program 720b using a parameter defined in a FORM tag 23. This script is automatically executed after the Web page is read into the Web browser 220b, because the script is assigned to an onLoad event by a BODY tag 22.

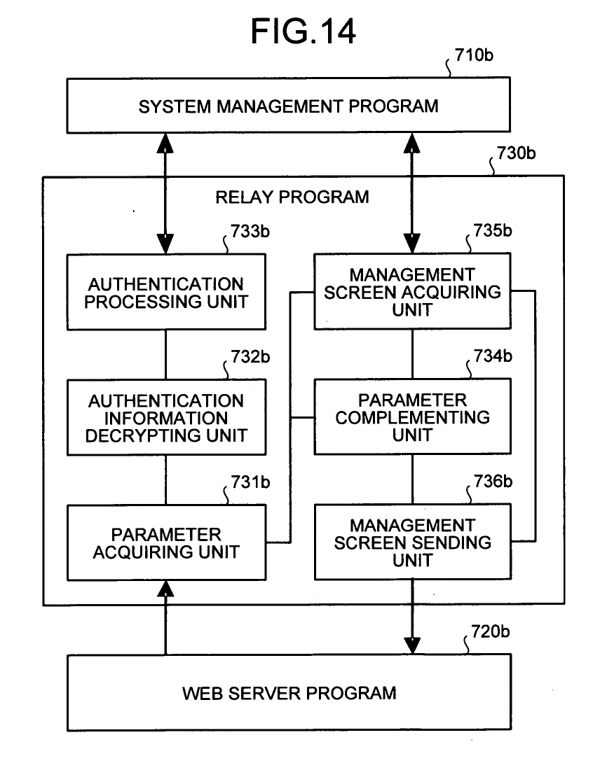

FIG. 14 is a block diagram of the relay program 730b shown in FIG. 10. The relay program 730b includes a parameter acquiring unit 731b, an authentication information decrypting unit 732b, an authentication processing unit 733b, a parameter complementing unit 734b, a management screen acquiring unit 735b, and a management screen transmitting unit 736b.

The parameter acquiring unit 731b is a processing unit that receives a call based on a common gateway interface (CGI) calling mechanism from the Web server program 720b, and acquires a parameter transmitted from the Web browser 220b. The authentication information decrypting unit 732b is a processing unit that decrypts a log in and a password, when the log in and the password encrypted are included in the parameter acquired. The authentication processing unit 733b performs an authentication process with respect to the system management program 710b using the log in and the password decrypted.

The parameter complementing unit 734b complements a parameter required for calling a management screen, based on the parameter acquired by the parameter acquiring unit 731b. The management screen acquiring unit 735b is a processing unit that calls a management screen using the parameter acquired by the parameter acquiring unit 731b and the parameter complemented by the parameter complementing unit 734b, and acquires the management screen called. The management screen transmitting unit 736b transmits screen data acquired by the management screen acquiring unit 735b to the Web browser 220b.

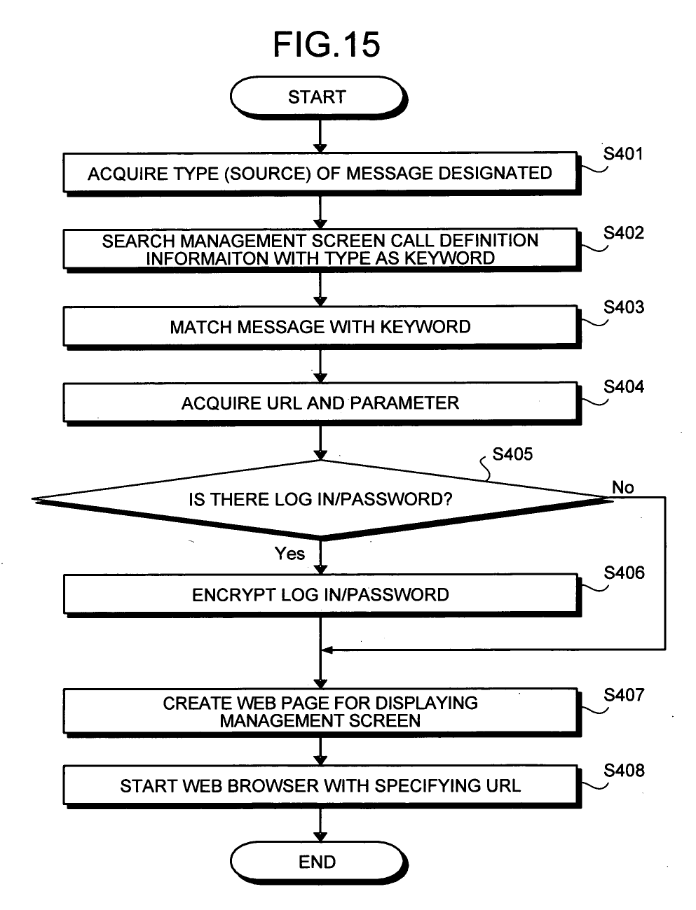

FIG. 15 is a flowchart of a process procedure performed by the operation management terminal program 210b shown in FIG. 11. When a specific message is selected from a message list screen displayed by the operation management terminal 200b, and when there is an instruction to display a management screen most related to the message selected, the message display control unit 211b receives the instruction, and notifies the instruction received to the management screen selecting unit 213b.

Upon receiving a notification from the message display control unit 211b, the management screen selecting unit 213b acquires a value of a data item of the type indicating a source of the message (Step S401), and instructs the management screen call definition acquiring unit 214b to acquire information for which the value of the type matches from the management screen call definition information 120b (Step S402).

Subsequently, the information acquired is selected one by one in an order of priority, and the information selected is checked whether the key word is matched with the message text of the message (Step S403). When there is information matched, values of items, a URL, a parameter, a log in, and a password contained in the information, are acquired (Step S404).

When values are set for the items, the log in and the password, (“YES” at Step S405), the authentication information encrypting unit 217b encrypts the both items (Step S406). If neither of the items is encrypted (“NO” at Step S405), the encryption is skipped.

Then, the information acquired at the Step S404, the information encrypted at the Step S406, and values of various data items of the message selected are delivered to the Web page creating unit 218b to create a Web page for displaying a management screen (Step S407), and an instruction is given to the management screen display unit 216b to start a Web browser with specifying the Web page (Step S408).

In this manner, the operation management terminal program 210b executes a process of selecting a management screen most related to a message selected, creating a Web page for displaying the management screen selected, and staring a Web browser with specifying the Web page created.

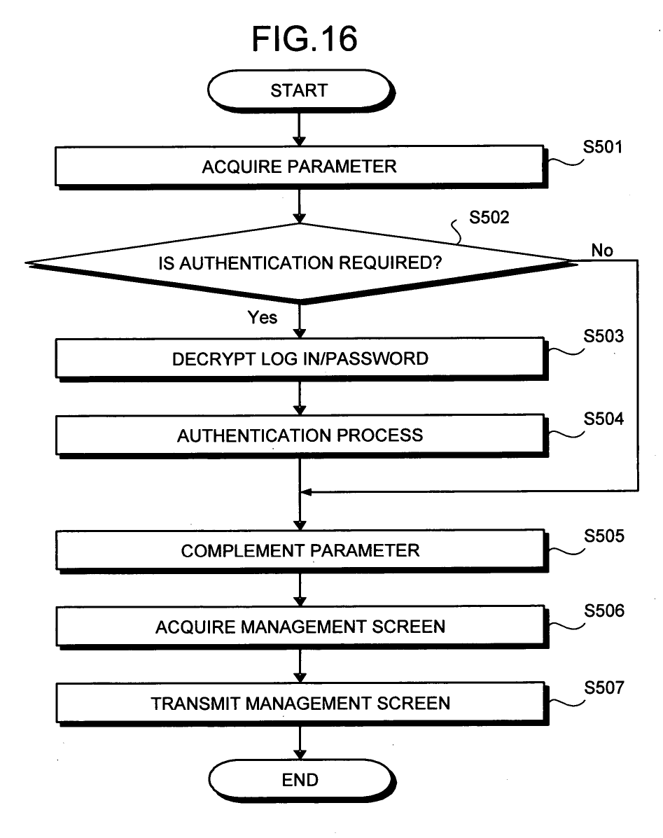

FIG. 16 is a flowchart of a process procedure performed by the relay program 730b shown in FIG. 14. The parameter acquiring unit 731b receives a call from the Web server program 720b, and acquires a parameter transmitted from the Web browser 220b (Step S501).

When the system management program 710b that is a target for acquiring a management screen requires an authentication (“YES” at Step S502), the authentication information decrypting unit 732b performs decryption of the log in and the password (Step S503), and the authentication processing unit 733b performs an authentication process with respect to the system management program 710b (Step S504). If the system management program 710b does not require an authentication (“NO” at Step S502), the Step S503 and the Step S504 are skipped.

The parameter complementing unit 734b complements a parameter required for calling a management screen using the parameter acquired at the Step S501 (Step S505). Then, the parameter screen acquiring unit 735b calls a management screen using the parameter acquired at the Step S501 and the parameter complemented at the Step S505, and acquires the management screen called (Step S506). The management screen transmitting unit 736b transmits the management screen acquired in this way to the Web browser 220b via the Web server program 720b (Step S507).

In this manner, the relay program 730b executes a process of performing an authentication process with respect to a system management program when needed, calling a management screen by complementing a parameter that is not managed by the operation management system, acquiring the management screen called, and transmitting the management screen acquired to a Web browser.

As described above, according to the second embodiment, because the relay program 730b complements a parameter that is not managed by the operation management system, it is possible to display a management screen, even when a parameter necessary for displaying the management screen is not included in the message log DB 130b.

Furthermore, a Web page created by the Web page creating unit 219b automatically transmits a parameter using a POST request. Therefore, even when a long parameter is required for displaying a management screen, it is possible to transmit the parameter normally, without having a manual operation.

Moreover, the relay program 730b performs, if necessary, an authentication process using a log in and a password delivered as a parameter. Therefore, even when an authentication is required for displaying a management screen, it is possible to display the management screen without displaying an authentication screen.

According to the present invention, it is possible to closely link a message displayed on an operation management terminal with a Web-based management screen provided by a system management program.

Furthermore, it is possible to transmit the parameter normally using a POST request, without having a manual operation.

Moreover, even when the operation management system does not manage a necessary parameter to display a management screen, it is possible to normally display the management screen.

Furthermore, even when an authentication is necessary to display a management screen, it is possible to display the management screen without displaying an authentication screen.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer program product that implements on a computer a method of controlling an operation management terminal to display message information for system management output form a plurality of system management units in an integrated fashion, the computer program product making the computer execute:
acquiring a rule for selecting a management screen most related to predetermined message information from among a plurality of Web-based management screens provided by the system management units;
acquiring information in which a parameter necessary for displaying the management screen selected is defined;
selecting a management screen most related to one of the message information displayed in an integrated fashion, based on the information acquired at the acquiring information; and
displaying a Web-based management screen selected at the selecting on a Web browser, using the parameter defined in the information acquired at the acquiring information.

2. The computer program product according to claim 1, further making the computer execute creating a Web page that includes a parameter for displaying the Web-based management screen selected at the selecting and a procedure for transmitting the parameter as a request, wherein
the displaying includes displaying the management screen by having the Web page created at the creating read into the Web browser.

3. An operation management terminal that displays message information for system management output form a plurality of system management units in an integrated fashion, comprising:
a rule acquiring unit that acquires a rule for selecting a management screen most related to predetermined message information from among a plurality of Web-based management screens provided by the system management units;
an information acquiring unit that acquires information in which a parameter necessary for displaying the management screen selected is defined;
a management screen selecting unit that selects a management screen most related to one of the message information displayed in an integrated fashion, based on the information acquired by the information acquiring unit; and
a management screen displaying unit that displays a Web-based management screen selected by the management screen selecting unit on a Web browser, using the parameter defined in the information acquired by the information acquiring unit.

4. A method of controlling an operation management terminal to display message information for system management output form a plurality of system management units in an integrated fashion, comprising:
acquiring a rule for selecting a management screen most related to predetermined message information from among a plurality of Web-based management screens provided by the system management units;
acquiring information in which a parameter necessary for displaying the management screen selected is defined;
selecting a management screen most related to one of the message information displayed in an integrated fashion, based on the information acquired at the acquiring information; and
displaying a Web-based management screen selected at the selecting on a Web browser, using the parameter defined in the information acquired at the acquiring information.

5. Acomputer program product that implements on a computer a method of relaying information relating to displaying a screen between a system management unit that provides a Web-based management screen and a Web server, the computer program product making the computer execute:
acquiring a parameter included in a request received by the Web server;
complementing a parameter necessary for displaying a management screen provided by the system management unit, using the parameter acquired at the acquiring a parameter;
acquiring screen data by having the system management unit create a management screen using the parameter acquired at the acquiring a parameter and the parameter complemented at the complementing; and
transmitting the screen data acquired at the acquiring screen data to the Web server.

6. The computer program product according to claim 5, further making the computer execute performing an authentication process with respect to the system management unit, using authentication information included in the parameter acquired at the acquiring a parameter.

7. The computer program product according to claim 6, further making the computer execute decrypting, when the authentication information included in the parameter acquired at the acquiring a parameter is encrypted, the parameter encrypted.

8. A relay apparatus that relays information relating to displaying a screen between a system management unit that provides a Web-based management screen and a Web server, comprising:
a parameter acquiring unit that acquires a parameter included in a request received by the Web server;
a parameter complementing unit that complements a parameter necessary for displaying a management screen provided by the system management unit, using the parameter acquired by the parameter acquiring unit;
a screen acquiring unit that acquires screen data by having the system management unit create a management screen using the parameter acquired by the parameter acquiring unit and the parameter complemented by the parameter complementing unit; and
a screen transmitting that transmits the screen data acquired by the screen acquiring unit to the Web server.

9. A method of relaying information relating to displaying a screen between a system management unit that provides a Web-based management screen and a Web server, comprising:
acquiring a parameter included in a request received by the Web server;
complementing a parameter necessary for displaying a management screen provided by the system management unit, using the parameter acquired at the acquiring a parameter;
acquiring screen data by having the system management unit create a management screen using the parameter acquired at the acquiring a parameter and the parameter complemented at the complementing; and
transmitting the screen data acquired at the acquiring screen data to the Web server.
